(19) United States
(12) Patent Application Publication
(10) Pub. No.: US 2016/0361606 A1
(43) Pub. Date: Dec. 15, 2016

(54) Golf Ball Storage and Heating Assembly

(71) Applicant: Jack Holder, Sun Lakes, AZ (US)

(72) Inventor: Jack Holder, Sun Lakes, AZ (US)

(21) Appl. No.: 14/737,036

(22) Filed: Jun. 11, 2015

(51) Int. Cl. A63B 47/00; H05B 3/00

(52) U.S. Cl. CPC A63B 47/005; H05B 3/008

(57) ABSTRACT

A golf ball storage and heating assembly includes a housing has a top wall, a bottom wall and a peripheral wall extending therebetween and the top wall is substantially open to access an interior of the housing. A support is positioned within the housing and a mesh member is positioned upon the support. A lid is hingedly coupled to the housing. A heating unit is positioned within the housing to selectively heat the interior of the housing. A containment unit is positioned within the interior of the housing such that the containment unit is in thermal communication with the heating unit. The containment unit may contain a plurality of golf balls thereby facilitating the golf balls to be heated such that a driving distance of the golf balls is increased.

### BACKGROUND OF THE DISCLOSURE

### Field of the Disclosure

The disclosure relates to storage devices and more particularly pertains to a new storage device for heating golf balls to increase a driving distance of the golf balls.

### SUMMARY OF THE DISCLOSURE

An embodiment of the disclosure meets the needs presented above by generally comprising a housing has a top wall, a bottom wall and a peripheral wall extending therebetween and the top wall is substantially open to access an interior of the housing. A support is positioned within the housing and a mesh member is positioned upon the support. A lid is hingedly coupled to the housing. A heating unit is positioned within the housing to selectively heat the interior of the housing. A containment unit is positioned within the interior of the housing such that the containment unit is in thermal communication with the heating unit. The containment unit may contain a plurality of golf balls thereby facilitating the golf balls to be heated such that a driving distance of the golf balls is increased.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a golf ball storage and heating assembly according to an embodiment of the disclosure.

FIG. 2 is a top perspective view of an embodiment of the disclosure.

FIG. 3 is a cross sectional view taken along line 3-3 of FIG. 1 of an embodiment of the disclosure.

FIG. 4 is a right side view of an embodiment of the disclosure.

FIG. 5 is a cross sectional view taken along line 5-5 of FIG. 2 of an embodiment of the disclosure.

### DESCRIPTION OF THE PREFERRED EMBODIMENT

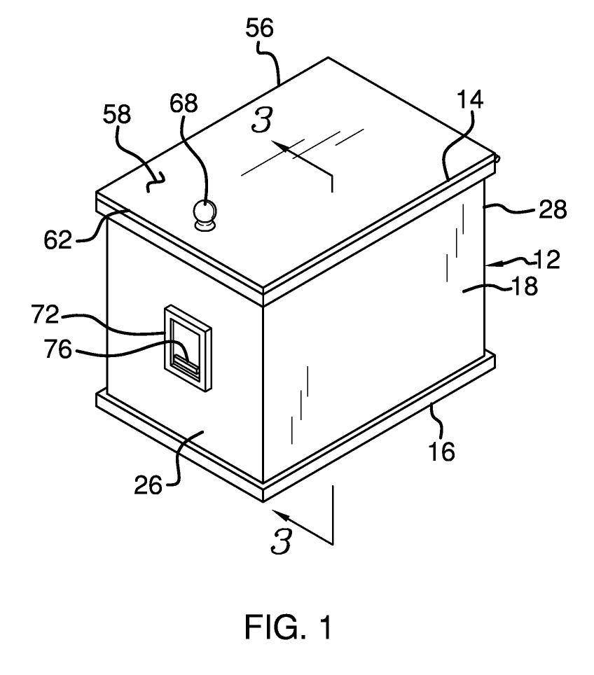

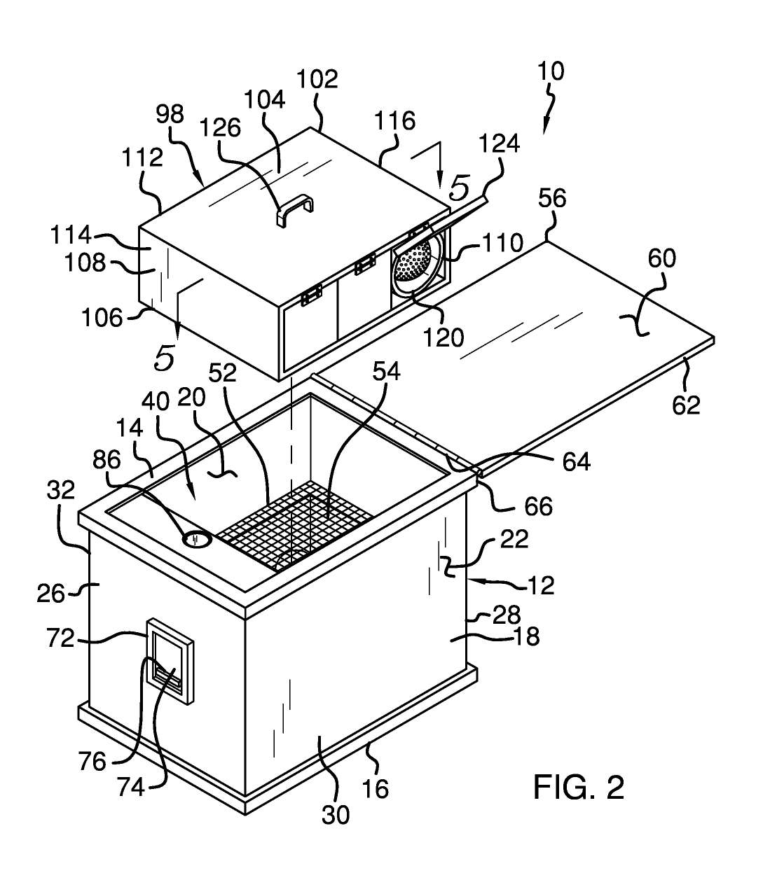

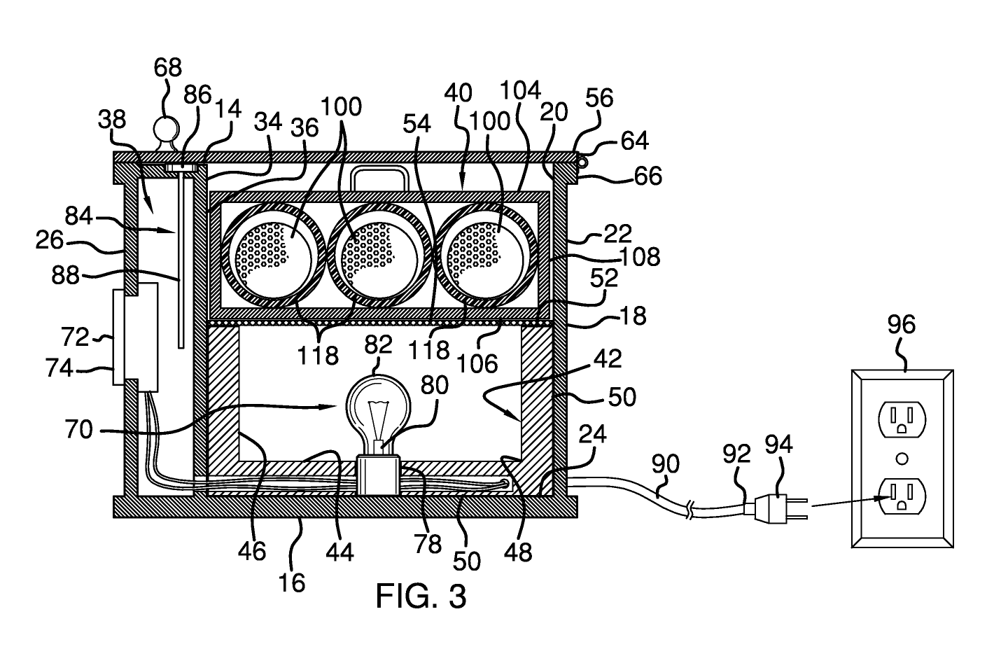

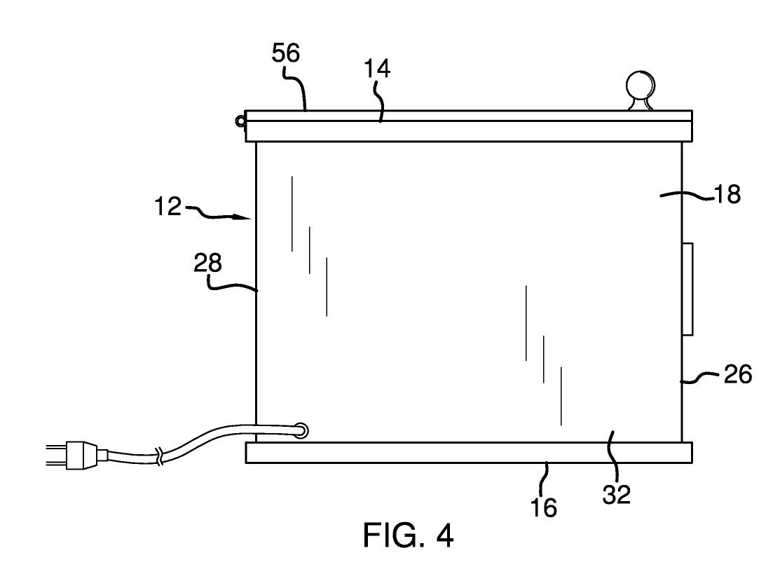

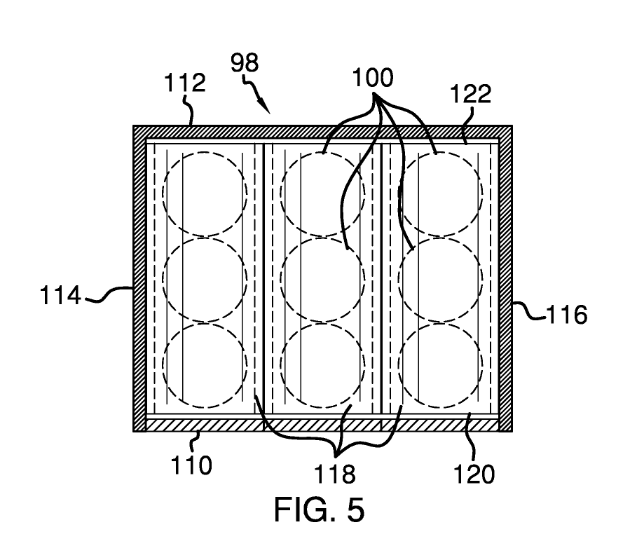

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5, the golf ball storage and heating assembly 10 generally comprises a housing 12 that has a top wall 14, a bottom wall 16 and a peripheral wall 18 extending therebetween and the top wall 14 is substantially open to access an interior of the housing 12. The peripheral wall 18 has an inner surface 20 and an outer surface 22 and the bottom wall 16 has an upper surface 24. The peripheral wall 18 has a front side 26, a back side 28, a first lateral side 30 and a second lateral side 32.

The housing 12 has a dividing wall 34 positioned within the interior and the dividing wall 34 extends between the top wall 14, the bottom wall 16, the first lateral side 30 and the second lateral side 32. The dividing wall 34 has an interior surface 36 facing the back side 28 of the housing 12. The dividing wall 34 is positioned closer to the front side 26 of the housing 12 than the back side 28 of the housing 12 to define a control space 38 between the dividing wall 34 and the front side 26 and a storage space 40 between the dividing wall 34 and the back side 28. Each of the top wall 14 and the bottom wall 16 extends outwardly from the front side 26, the back side 28, the first lateral side 30 and the second lateral side 32.

A support 42 is provided that has a lowermost wall 44 and a perimeter wall 46 coupled to and extending upwardly from an outer edge 48 of the lowermost wall 44. Each of the lowermost wall 44 and the perimeter wall 46 has an exterior surface 50 and the support 42 is positioned within the interior of the housing 12. The exterior surface 50 of the perimeter wall 46 abuts the inner surface 20 of the peripheral wall 18 corresponding to each of the first lateral side 30, the second lateral side 32 and the back side 28. The exterior surface 50 of the perimeter wall 46 abuts the interior surface 36 of the dividing wall 34 and the exterior surface 50 of the lowermost wall 44 abuts the upper surface 24 of the bottom wall 16 of the housing 12. The perimeter wall 46 has an upper edge 52 and the perimeter wall 46 extends upwardly along the inner surface 20 of the peripheral wall 18 and the interior surface 36 of the dividing wall 34 such that the upper edge 52 of the support 42 is positioned between the bottom wall 16 and the top wall 14 of the housing 12.

A mesh member 54 is positioned upon the upper edge 52 of the support 42. The mesh member 54 extends between the inner surface 20 corresponding to each of the first lateral side 30 and the second lateral side 32 of the peripheral wall 18 of the housing 12. Additionally, the mesh member 54 extends between the inner surface 20 corresponding to the back side 28 of the housing 12 and the interior surface 36 of the dividing wall 34. The mesh member 54 may be comprised of a rigid and heat resistant material.

A lid 56 is provided that has a top surface 58, a bottom surface 60 and a perimeter edge 62 extending therebetween. The perimeter edge 62 has a rear side 64, the top wall 14 of the housing 12 has a rearmost edge 66 and the rear side 64 is hingedly coupled to the rearmost edge 66. The lid 56 is positionable in a closed position having the bottom surface 58 engaging the top wall 14 to close the housing 12. The lid 56 is positionable in an open position to access the interior of the housing 12. A knob 68 is coupled to and extends upwardly from the top wall 14. The knob 68 is positioned adjacent to the front side 26 and the knob 68 is gripped to position the lid 56 between the closed position and the open position.

A heating unit 70 is positioned within the housing 12 and the heating unit 70 selectively heats the interior of the housing 12. The heating unit 70 comprises a control 72 extending through the front side 26 of the housing 12. The control 72 has an exposed side 74 with respect to the front side 26 of the housing 12 and the control 72 has a slide 76 positioned on the exposed side 74. The slide 76 is slidably positionable between a minimum position and a maximum position. The control 72 may comprise a rheostat or the like with an operational voltage of 110 VAC.

A socket 78 is coupled to the upper surface 24 of the bottom wall 16 such that the socket 78 extends upwardly through the lowermost wall 44 of the support 42 and the socket 78 is electrically coupled to the control 72. The socket 78 has a distal end 80 with respect to the bottom wall 16 and the distal end 80 is open. The socket 78 may comprise a light bulb socket or the like.

A light emitter 82 is positioned within the distal end 80 such that the light emitter 82 is electrically coupled to the socket 78. The light emitter 82 emits a maximum amount of heat energy when the slide 76 is positioned in the maximum position such that the light emitter 82 heats the interior of the housing 12 to a maximum temperature. Moreover, the light emitter 82 emits a minimum amount of heat energy when the slide 76 is positioned in the minimum position such that the light emitter 82 heats the interior of the housing 12 to a minimum temperature. The light emitter 82 may comprise an incandescent light bulb or the like with an operational wattage ranging between approximately 75 watts and 100 watts.

A thermometer 84 is provided that has a gauge 86 and a probe 88 extending downwardly from the gauge 86. The probe 88 extends downwardly through the top wall 14 such that the probe 88 is positioned within the control space 38 and the probe 88 is in thermal communication with the heating unit 70 such that the gauge 86 indicates a temperature of the interior of the housing 12. The gauge 86 abuts the top wall 14 such that the gauge 86 is visible. A power cord 90 is electrically coupled to the socket 78 and the power cord 90 extends outwardly from the back side 28 of the housing 12. The power cord 90 has a distal end 92 with respect to the back side 28 and the power cord 90 has a plug 94 electrically coupled to the distal end 82. The plug 94 may be electrically coupled to a power source 96 and the power source 96 may be an electrical outlet or the like.

A containment unit 98 is removably positioned within the interior of the housing 12 such that the containment unit 98 is in thermal communication with the heating unit 70. The containment unit 98 may contain a plurality of golf balls 100 thereby facilitating the golf balls 100 to be heated such that a driving distance of the golf balls 100 is increased. The golf balls 100 may be golf balls 100 of any conventional design. The containment unit 98 comprises a box 102 that has an upper wall 104, a lower wall 106 and an outer wall 108 extending therebetween. The outer wall 108 has a first lateral side 110, a second lateral side 112, a front side 114 and a back side 116. The first lateral side 110 is open to access an interior of the box 102 and the lower wall 106 is positioned upon the mesh member 54 such that the box 102 is in thermal communication with the heating unit 70.

A plurality of tubes 118 is provided that each has a first end 120 and a second end 122. Each of the first end 120 and the second end 122 is open and each of the tubes 118 is positioned within an interior of the box 102. The second end 122 of each of the tubes 118 abuts the second lateral side 112 of the box 102 and the first end 120 of each of the tubes 118 is aligned with the first lateral side 110 of the box 102. The tubes 118 are distributed between the front side 114 and the back side 116 of the box 102 and the first end 120 of each of the tubes 118 may insertably receive the golf balls 100 such that each of the tubes 118 contains a selected number of the golf balls 100. The tubes 118 place the golf balls 100 in thermal communication with the heating unit 70 when the box 102 is positioned within the housing 12.

A door 124 is hingedly coupled to the first lateral side 110 of the box 102. The door 124 is positionable in a closed position to cover the first end 120 of each of the tubes 118 and the door 124 is positionable in an open position to access the first end 120 of each of the tubes 118. The door 124 may be one of a plurality of doors 124 and each of the doors 124 may be aligned with the first end 120 of one of the tubes 118. A handle 126 is coupled to the upper wall 104 of the box 102 and the handle 126 may be gripped such that the box 102 is inserted within the housing 12 and removed from the housing 12.

In use, the selected number of golf balls 100 is positioned within the tubes 118. The box 102 is positioned upon the mesh member 54 and the lid 56 is placed in the closed position. The slide 76 on the control 72 is positioned at a selected point to establish the desired temperature at which the housing 12 is to be heated. The light emitter 82 is actuated and begins to heat the interior of the housing 12. The box 102 remains within the housing 12 until one of the golf balls 100 is to be utilized. One of the golf balls 100 is removed from the box 102 after the interior of the housing 12 reaches the desired temperature and the golf ball 100 is utilized in the convention of the game of golf. The heating unit 70 is used to heat the golf balls 100 when the golf balls 100 are to be utilized in a cold environment. Warming the golf balls 100 to the desired temperature allows the golf balls 100 to be driven a greater distance than would otherwise be possible in the cold environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golf ball storage and heating assembly configured to warm a plurality of golf balls to a selected temperature thereby increasing a driving distance of the golf balls, said assembly comprising:
a housing having a top wall, a bottom wall and a peripheral wall extending therebetween, said top wall being substantially open to access an interior of said housing;
a support positioned within said housing;
a mesh member being positioned upon said support;
a lid hingedly coupled to said top wall;
a heating unit being positioned within said housing, said heating unit selectively heating said interior of said housing; and
a containment unit being positioned within said interior of said housing such that said containment unit is in thermal communication with said heating unit, said containment unit being configured to contain a plurality of golf balls thereby facilitating the golf balls to be heated such that a driving distance of the golf balls is increased.

2. The assembly according to claim 1, wherein said, said peripheral wall having an inner surface and an outer surface, said bottom wall having an upper surface, said peripheral wall having a front side, a back side, a first lateral side and a second lateral side, said housing having a dividing wall positioned within said interior, said dividing wall extending between said top wall, said bottom wall, said first lateral side and said second lateral side, said dividing wall having an interior surface facing said back side, said dividing wall being positioned closer to said front side than said back side to define a control space between said dividing wall and said front side and a storage space between said dividing wall and said back side, each of said top wall and said bottom wall extending outwardly from said front side, said back side, said first lateral side and said second lateral side.

3. The assembly according to claim 2, wherein said support has a lowermost wall and a perimeter wall coupled to and extending upwardly from an outer edge of said lowermost wall, each of said lowermost wall and said perimeter wall having an exterior surface, said support being positioned within said interior, said exterior surface of said perimeter wall abutting said inner surface corresponding to each of said first lateral side, said second lateral side and said back side, said exterior surface abutting said interior surface of said dividing wall, said exterior surface of said lowermost wall abutting said upper surface of said bottom wall of said housing, said perimeter wall having an upper edge, said perimeter wall extending upwardly along said inner surface of said peripheral wall and said interior surface of said dividing wall such that said upper edge is positioned between said bottom wall and said top wall of said housing.

4. The assembly according to claim 2, wherein said mesh member extends between said inner surface corresponding to each of said first lateral side and said second lateral side, said mesh member extending between said inner surface corresponding to said back side and said interior surface of said dividing wall.

5. The assembly according to claim 1, wherein:
said peripheral wall has a front side;
said bottom wall has an upper surface;
said housing has a control space; and
said heating unit comprises a control extending through said front side, said control having an exposed side with respect to said front side, said control having a slide positioned on said exposed side, said slide being slidably positionable between a minimum position and a maximum position.

6. The assembly according to claim 5, further comprising a socket being coupled to said upper surface of said bottom wall such that said socket extends upwardly through said exterior surface of said lowermost wall, said socket being electrically coupled to said control, said socket having a distal end with respect to said bottom wall, said distal end being open.

7. The assembly according to claim 6, further comprising a light emitter being positioned within said distal end such that said light emitter is electrically coupled to said socket, said light emitter emitting a maximum amount of heat energy when said slide is positioned in said maximum position such that said light emitter heats said interior to a maximum temperature, said light emitter emitting a minimum amount of heat energy when said slide is positioned in said minimum position such that said light emitter heats said interior to a minimum temperature.

8. The assembly according to claim 7, further comprising a thermometer having a gauge and a probe extending downwardly from said gauge, said probe extending downwardly through said top wall such that said probe is positioned within said control space, said probe being in thermal communication with said heating unit such that said gauge indicates a temperature of said interior, said gauge abutting said top wall such that said gauge is configured to be visible.

9. The assembly according to claim 8, further comprising a power cord being electrically coupled to said socket, said power cord extending outwardly from said back side, said power cord having a distal end with respect to said back side, said power cord having a plug electrically coupled to said distal end, said plug being configured to be electrically coupled to a power source.

10. The assembly according to claim 1, wherein said containment unit comprises a box having an upper wall, a lower wall and an outer wall extending therebetween, said outer wall having a first lateral side, a second lateral side, a front side and a back side, said first lateral side being open to access an interior of said box, said lower wall being positioned upon said mesh member such that said box is in thermal communication with said heating unit.

11. The assembly according to claim 10, wherein a plurality of tubes each having a first end and a second end, each of said first end and said second end being open, each of said tubes being positioned within an interior of said box, said second end of each of said tubes abutting said second lateral side of said box, said first end of each of said tubes being aligned with said first lateral side, said tubes being distributed between said front side and said back side of said box, said first end of each of said tubes being configured to insertably receive the golf balls such that each of said tubes contains a selected number of the golf balls, said tubes being configured to place the golf balls in thermal communication with said heating unit when said box is positioned within said housing.

12. The assembly according to claim 11, further comprising a door hingedly coupled to said first lateral side, said door being positionable in a closed position to cover said first end of each of said tubes, said door being positionable in an open position to access said first end of each of said tubes.

13. The assembly according to claim 12, further comprising a handle coupled to said upper wall, said handle being configured to be gripped such that said box is inserted within said housing and removed from said housing.

14. The assembly according to claim 1, wherein said lid has a top surface, a bottom surface and a perimeter edge extending therebetween, said perimeter edge having a rear side, said top wall having a rearmost edge, said rear side being hingedly coupled to said rearmost edge, said lid being positionable in a closed position having said bottom surface engaging said top wall to close said housing, said lid being positionable in an open position to access said interior, a knob coupled to and extending upwardly from said top wall, said knob being positioned adjacent to said front side, said knob being configured to be gripped to position said lid between said closed position and said open position.

15. A golf ball storage and heating assembly configured to warm a plurality of golf balls to a selected temperature thereby increasing a driving distance of the golf balls, said assembly comprising:
a housing having a top wall, a bottom wall and a peripheral wall extending therebetween, said top wall being substantially open to access an interior of said housing, said peripheral wall having an inner surface and an outer surface, said bottom wall having an upper surface, said peripheral wall having a front side, a back side, a first lateral side and a second lateral side, said housing having a dividing wall positioned within said interior, said dividing wall extending between said top wall, said bottom wall, said first lateral side and said second lateral side, said dividing wall having an interior surface facing said back side, said dividing wall being positioned closer to said front side than said back side to define a control space between said dividing wall and said front side and a storage space between said dividing wall and said back side, each of said top wall and said bottom wall extending outwardly from said front side, said back side, said first lateral side and said second lateral side;
a support having a lowermost wall and a perimeter wall coupled to and extending upwardly from an outer edge of said lowermost wall, each of said lowermost wall and said perimeter wall having an exterior surface, said support being positioned within said interior, said exterior surface of said perimeter wall abutting said inner surface corresponding to each of said first lateral side, said second lateral side and said back side, said exterior surface abutting said interior surface of said dividing wall, said exterior surface of said lowermost wall abutting said upper surface of said bottom wall of said housing, said perimeter wall having an upper edge, said perimeter wall extending upwardly along said inner surface of said peripheral wall and said interior surface of said dividing wall such that said upper edge is positioned between said bottom wall and said top wall of said housing;
a mesh member being positioned upon said upper edge of said support, said mesh member extending between said inner surface corresponding to each of said first lateral side and said second lateral side, said mesh member extending between said inner surface corresponding to said back side and said interior surface of said dividing wall;
a lid having a top surface, a bottom surface and a perimeter edge extending therebetween, said perimeter edge having a rear side, said top wall having a rearmost edge, said rear side being hingedly coupled to said rearmost edge, said lid being positionable in a closed position having said bottom surface engaging said top wall to close said housing, said lid being positionable in an open position to access said interior;
a knob coupled to and extending upwardly from said top wall, said knob being positioned adjacent to said front side, said knob being configured to be gripped to position said lid between said closed position and said open position;
a heating unit being positioned within said housing, said heating unit selectively heating said interior of said housing, said heating unit comprising:
a control extending through said front side, said control having an exposed side with respect to said front side, said control having a slide positioned on said exposed side, said slide being slidably positionable between a minimum position and a maximum position;
a socket being coupled to said upper surface of said bottom wall such that said socket extends upwardly through said exterior surface of said lowermost wall, said socket being electrically coupled to said control, said socket having a distal end with respect to said bottom wall, said distal end being open;
a light emitter being positioned within said distal end such that said light emitter is electrically coupled to said socket, said light emitter emitting a maximum amount of heat energy when said slide is positioned in said maximum position such that said light emitter heats said interior to a maximum temperature, said light emitter emitting a minimum amount of heat energy when said slide is positioned in said minimum position such that said light emitter heats said interior to a minimum temperature;
a thermometer having a gauge and a probe extending downwardly from said gauge, said probe extending downwardly through said top wall such that said probe is positioned within said control space, said probe being in thermal communication with said heating unit such that said gauge indicates a temperature of said interior, said gauge abutting said top wall such that said gauge is configured to be visible; and
a power cord being electrically coupled to said socket, said power cord extending outwardly from said back side, said power cord having a distal end with respect to said back side, said power cord having a plug electrically coupled to said distal end, said plug being configured to be electrically coupled to a power source; and
a containment unit being positioned within said interior of said housing such that said containment unit is in thermal communication with said heating unit, said containment unit being configured to contain a plurality of golf balls thereby facilitating the golf balls to be heated such that a driving distance of the golf balls is increased, said containment unit comprising:
a box having an upper wall, a lower wall and an outer wall extending therebetween, said outer wall having a first lateral side, a second lateral side, a front side and a back side, said first lateral side being open to access an interior of said box, said lower wall being positioned upon said mesh member such that said box is in thermal communication with said heating unit;
a plurality of tubes each having a first end and a second end, each of said first end and said second end being open, each of said tubes being positioned within an interior of said box, said second end of each of said tubes abutting said second lateral side of said box, said first end of each of said tubes being aligned with said first lateral side, said tubes being distributed between said front side and said back side of said box, said first end of each of said tubes being configured to insertably receive the golf balls such that each of said tubes contains a selected number of the golf balls, said tubes being configured to place the golf balls in thermal communication with said heating unit when said box is positioned within said housing;
a door hingedly coupled to said first lateral side, said door being positionable in a closed position to cover said first end of each of said tubes, said door being positionable in an open position to access said first end of each of said tubes; and
a handle coupled to said upper wall, said handle being configured to be gripped such that said box is inserted within said housing and removed from said housing.
